(19) United States
(12) Patent Application Publication
(10) Pub. No.: US 2021/0081955 A1
(43) Pub. Date: Mar. 18, 2021

(54) SYSTEMS AND METHODS FOR INTEGRATING BUSINESS PROCESSES INTO VOICE ASSISTANT PLATFORMS

(71) Applicant: Talkdesk, Inc, San Francisco, CA (US)

(72) Inventors: Phillip Zeelig, San Jose, CA (US); Charanya Kannan, Oakland, CA (US); Bruno Antunes, São Silvestre (PT); Tiago Paiva, San Francisco, CA (US)

(21) Appl. No.: 16/569,899

(22) Filed: Sep. 13, 2019

(51) Int. Cl. G06Q 30/00

(52) U.S. Cl. CPC G06Q 30/016

(57) ABSTRACT

In one embodiment, a skill is provided that is installed into voice assistants. The skill incorporates functionality from multiple brands, allowing users to interact with multiple brands using a single skill. The brands may have in common a platform that they already use to provide customer support such as a call center. The platform may leverage existing business processes already used to provide customer support, as well as information associated with the brands from external sources such as customer relationship management platforms, to create skill functionality for each brand.

### BACKGROUND

Voice assistants, such as Alexa and Google Home, are rapidly becoming common features in many homes. Users use the voice assistants to receive weather, news, control lights, play music, and to perform a variety of other tasks and activities.

Like the apps commonly found on smartphones, users can extend the functionality of the voice assistants by installing what are commonly known as skills. After installing a skill, the user can use the skill by speaking a keyword or phrase associated with the skill. For example, a user may install a skill that is a puzzle game called “Puzzler”. The user may instruct their voice assistant to start the puzzle game by saying a keyword or phase such as “Start Puzzler” or “Lets play Puzzler”.

While voice skills are popular, there are some drawbacks associated with voice skills. First, because of the audio-first nature of voice assistants, it may be difficult for users to learn what voice skills are available using the voice assistant. For example, users may have to browse available voice skills using their smartphone.

Second, with respect to brands, it may be difficult to convince a user to download and install a voice skill specific to a brand. Brands such as retailers, restaurants, hotels, etc. often provide smartphone apps that users can use to communicate with the brand. For example, a clothing retailer may provide an app that users can use to purchase clothes, start return processes, learn about upcoming sales or events, and locate nearby locations. Because voice assistants and voice skills are typically designed to use only voice and audio, they often do not support all of the features of their corresponding smartphone applications. Accordingly, it may be difficult to convince users of voice assistants to download and install voice skills corresponding to the brands that they use and interact with.

Third, creating a voice skill is difficult and time consuming for a brand. Given the cost associated with the creation of a voice skill and the reluctance of users to download and install voice skills, there is currently little incentive for many brands to invest the time and money that is required to create a voice skill that their customers will interact with.

### SUMMARY

In one embodiment, a skill is provided that is installed into voice assistants. The skill incorporates functionality from multiple brands, allowing users to interact with multiple brands using a single skill. The brands may have in common a platform that they already use to provide customer support such as a call center. The platform may leverage existing business processes already used to provide customer support, as well as information associated with the brands from external sources such as customer relationship management platforms, to create skill functionality for each brand.

The embodiments described herein solve many of the problems associated with the prior art described above. First, by combining multiple brands into a single skill, users are highly incentivized to install the skill to access the many brands associated with the skill. Previously, users had to install a skill for each individual brand, which was time consuming and offered little benefit. Second, by leveraging customer support information already provided by each brand to create the skill functionality, the amount of time and effort needed by a brand to create a skill is greatly reduced.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example system architecture for incorporating voice assistants into a contact center within the context of the environment of FIG. 1;

FIGS. 3-5 are illustrations of an example methods for adding a brand to a voice skill;

FIG. 6 is an illustration of an example method for performing a business process for a brand based on text received from a voice assistant platform;

FIG. 7 is an illustration of an example method for instructing an agent to contact a customer;

FIG. 8 is an illustration of an example method for performing a business process associated with a determined intent; and

FIG. 9 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

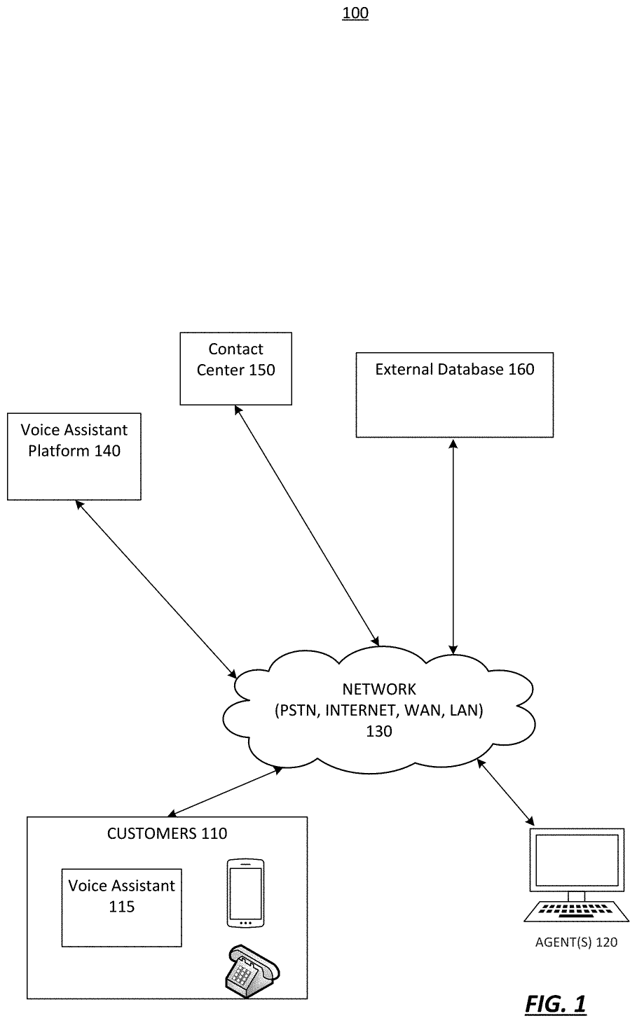

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with agent(s) 120 through a network 130 and one or more of text or multimedia channels. The agent(s) 120 may be remote from the contact center 150 and handle communications with customers 110 on behalf of an enterprise. The agent(s) 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

Agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (Al), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

The contact center 150 may provide the real-time and non-real-time communication services to what are referred to herein as one or more brands. A brand may be an entity, such as a corporation or individual, that provides one or more goods and services to customers 110. Examples of brands include retailers (e.g., clothing retailers, book retailers, and grocery stores), and service providers (e.g., car sharing providers, hotel or transportation reservation services, and food delivery services). Any type of entity that provides a good or service to customers 110 may be considered a brand.

Examples, of real-time and non-real-time services provided by the contact center 150 for one or more brands may include customer support services. Customer support services may include handling phone calls, emails, and other communications received by customers 110, for example.

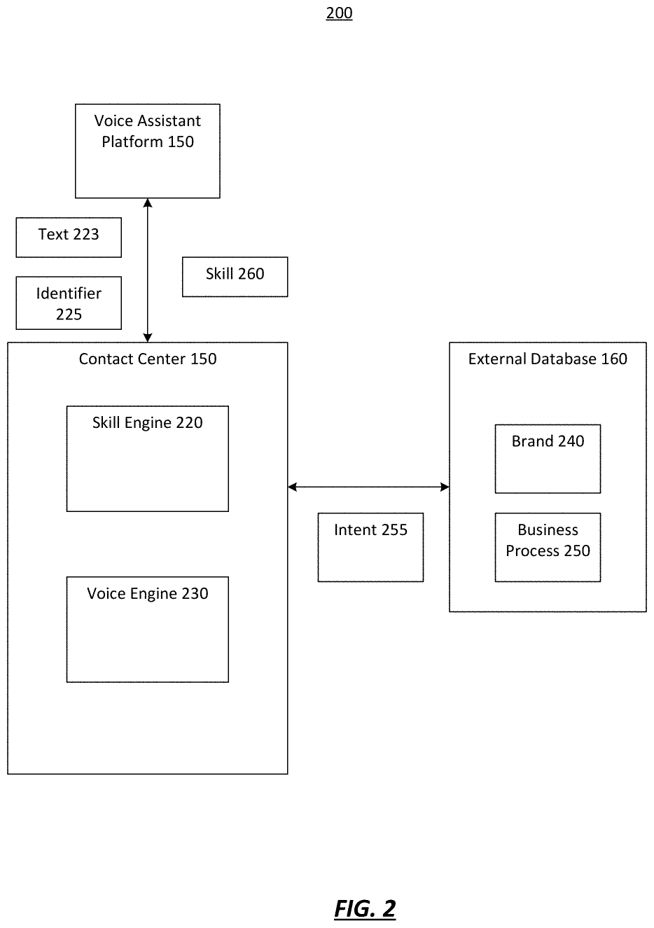

The contact center 150 may provide real-time and non-real time services for a brand using one or more business processes. As will be described further with respect to FIG. 2, a business process may be a series of steps that are taken by an agent 120 on behalf of a brand in response to a request from a customer 110. For example, one business process may be used by an agent 120 when a customer 110 calls to return a product and another business process may be used by an agent 120 when a customer 110 calls with a complaint.

Each brand associated with the contact center 150 may provide the contact center 150 with their various business processes and other information. In some embodiments, the contact center 150 may receive the business processes and other information about a brand by interacting with one or more external databases 160 associated with the brand. The information may include information such as identifiers or profiles (e.g., customer names, contact information, order history, etc.) of customers 110 associated with the brand, and information about one or more products associated with the brand (inventory information, product details, etc.).

In some implementations, the external databases 160 may include customer relationship management (“CRM”) platforms. A CRM platform is software that helps entities (i.e., brands) manage their relationships with customers 110, potential customers 110, and suppliers. Other types of platforms and external databases 160 may be supported.

The contact center 150 may further allow customers 110 to interact with brands associated with the contact center 150 through one or more voice assistants 115 and one or more corresponding voice assistant platforms 140. A voice assistant 115 is a digital assistant that uses voice recognition, speech synthesis, and natural language processing (“NLP”) to provide a service through an associated voice assistant platform 140. Typically, a customer 110 installs a voice assistant 115 on a computer or smart phone or purchases a device that includes standalone voice assistant 115 preinstalled. The customer 110 may then interact with the voice assistant 115 by speaking a “wake word”, or by pressing a button, that causes the voice assistant 115 to begin recording audio that is spoken by the customer 110. The recorded audio is provided to the corresponding voice assistant platform 140 by the voice assistant 115. The voice assistant platform 140 may then process the recorded audio using voice recognition, speech synthesis, or NLP, may perform one or more actions based on the processing, and may provide results of the one or more actions to the voice assistant 115. The voice assistant 115 may then “speak” or otherwise convey the results to the customer 110.

For example, a customer 110 may speak the phrase “Voice assistant, what is the weather?” In response to hearing the phrase “voice assistant”, the voice assistant 115 may record the audio comprising “what is the weather?” and may provide the recorded audio to the voice assistant platform 140. The voice assistant platform 140 may process the audio and may determine that the customer 110 associated with the voice assistant 115 wants to learn the weather forecast. The voice assistant platform 140 may then determine a zip code associated with the customer 110, may retrieve the weather forecast corresponding to the zip code, and may provide data that includes the forecast to the voice assistant 115 associated with the customer 110. The voice assistant 115 may then speak and/or display the forecast to the customer 110.

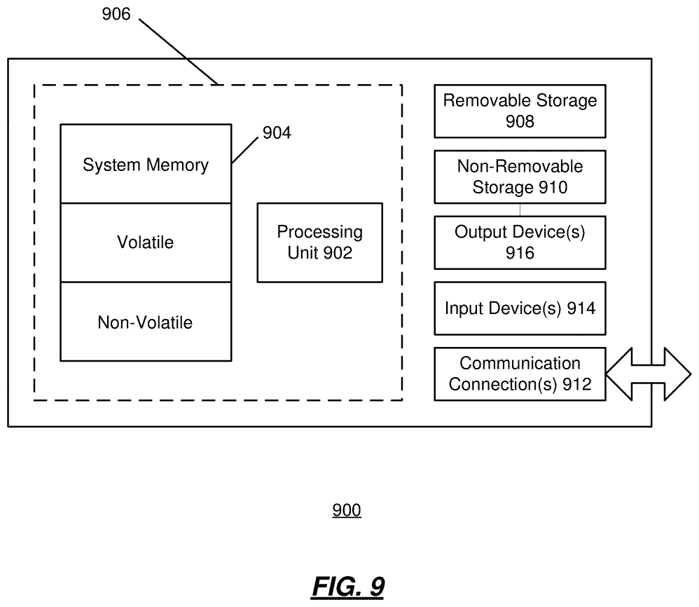

FIG. 2 is an illustration of an example system architecture for incorporating voice assistants 115 into a contact center 150. As shown the contact center 150 includes various modules including a skill engine 220 and a voice engine 230. More or fewer modules may be supported by the contact center 150. Depending on the embodiment, each of the contact center 150, skill engine 220, and voice engine 230 may be implemented together or separately by one or more general purpose computing devices such as the computing system 900 illustrated with respect to FIG. 9.

The skill engine 220 is configured to incorporate a brand 240, and brand-related functionality, into a skill 260 that is installed and executed by the voice assistant platform 150. As described above, a customer 110 (i.e., user) may add to the functionality of the voice assistant 115 and the voice assistant platform 150 by installing one or more skills 260. The customer 110 may then invoke the skill 260 by speaking one or more keywords associated with the skill 260.

The skill engine 220 may add a brand 260 into the skill 260 by first providing a tool that a user or administrator associated with the brand 240 can incorporate one or more existing business processes 250 associated with the brand 240 into the skill 260. Depending on the embodiment, the tool may be provided or displayed to the user via the contact center 150. For example, a user of the contact center 150 may indicate that they would like to incorporate their brand 240 into a skill 260. In response, the skill engine 220 may generate a graphical-user interface (“GUI”) through which the user may create the skill 260.

In order to allow for the user to create a skill 260 for a brand 240, initially the skill engine 220 may interface with an external database 160 associated with the brand 240 and may retrieve one or more business processes 250 associated with the brand 240. The business process 250 may be business processes 250 already being used by the brand 240 with respect to the contact center 150. The external database 160 may be part of a CRM platform used by the brand 240.

For example, a business process 250 that is used by agents 120 associated with a contact center 150 when handling returns for a brand 240 may include the following steps or actions:
1st Step/Action: Request the end user for their order number if not already known;
2nd Step/Action: Verify that the order is eligible for return;
3rd Step/Action: If eligible, create the return merchandise authorization (RMA) in an external system;
4th Step/Action: Use context from the conversation to populate the details within the RMA record;
5th Step/Action: Send RMA confirmation to the end user via text or email and provide shipping labels.

The skill engine 220 may display the various business processes 250 associated with the brand 240 in the GUI that is presented to the user by the contact center 150. The user may then select the business processes 250 that they would like to include in their skill 260. For example, the brand 240 may want to allow users to order products through the skill 260 and to return products using the skill 260. Accordingly, the user may select the corresponding business processes 250 in the GUI.

After selecting one or more business processes 250, the skill engine 220 may associate each business process 250 with an intent 255. Depending on the embodiment, an intent 255 may be one or more keywords or phrases that may be used to evoke the associated business process when spoken by a customer 110 while using the skill 260. Continuing the above examples, the intent 255 for the business process 250 to return a product may use keywords such as “return”, “exchange”, “defective”, “broken”, or “fit”. The intent 255 for the business process 250 to purchase a product may use keywords such as “buy”, “purchase”, or “shop”.

In some embodiments, the skill engine 220 may associate the business processes 250 with intents 255 by providing a GUI through which the user can enter keywords for each selected business process 250. The entered keywords for a business process 250 may then be associated with the business process 250 by the skill engine 220. The keywords for an intent 255 may be initially suggested or prepopulated in the GUI by the skill engine 220 based on one or more words or phrases that appear in the associated business process 250, for example. Alternatively or additionally, the keywords may be initially suggest by an artificial intelligence that was trained using the intents 255 provided or selected by previous users, for example.

The skill engine 220 may associate the brand 240 with the selected business processes 250 and selected intents 255 and may create a skill 250 for the brand 240 using the associated business processes 250 and intents 255. A customer 110 may then select and install the skill 260 on their voice assistant 115.

Alternatively or additionally, the skill engine 220 may add the brand 240 to an omnibus skill 260 that includes multiple brands 240. For example, the skill 260 may include some or all of the brands 240 that are associated with the contact center 150. As will be described further below with respect to the voice engine 230, when a customer 110 uses the skill 260 the voice engine 230 may determine which brand the 240 the customer 110 is referring to based on information such as the specific words spoken by the customer 110, and data associated with the customer 110 (in the contact center 150 or external database 160) that associates the customer 110 with the brand 240, for example.

The voice engine 230 is configured to perform backend processing related to the performance of the skill 260 for the voice assistant platform 150. When a customer 110 invokes the skill 260 on their voice assistant 115, the voice assistant platform 150 may process audio or voice data associated with the invocation and may provide text 223 corresponding to the audio or voice data to the voice engine 230. Depending on the embodiment, the text 223 may include text that identifies a brand 240 as well as one or more intents 255.

For example, a customer 110 may invoke the skill 260 using a “magic word” or phase that names the skill 260. For a skill 260 named “omnibus”, the customer 120 may invoke the skill 260 by saying aloud “Voice Assistant, start ‘Omnibus’. After the voice assistant 115 indicates that the omnibus skill 260 has started, the customer 110 may speak a command such as “Check the status of my order with Shoebrand. The voice assistant platform 150 may then use voice processing techniques (e.g., voice recognition, speech synthesis, or NLP) to extract text 223 from the spoken command and may provide the text 223 to the voice engine 230.

The text 223 may be provided to the voice engine 230 along with one or more identifiers 225 of the customer 110 that provided the text 223. Depending on the embodiment, the identifier 225 may be an identifier of the customer to the voice assistant platform 150 and may include a number assigned to the customer 110 by the voice assistant platform 150, or a telephone number or email address associated with the customer 110. Other types of identifiers 225 may be supported.

After receiving the text 223 and identifier 225, the voice engine 230 may attempt to determine the brand 240 associated with the text 223. Depending on the embodiment, the voice engine 230 may determine the brand 240 by parsing the text 223 for the name of a brand 240. Other methods may be used. If the voice engine 230 cannot determine the brand 240, the voice engine 230 may generate an instruction for the voice assistant platform 150 to ask the customer 110 to clarify what brand 240 they are referencing.

In some embodiments, the voice engine 230 may determine the brand 240 by first determining which brands 240 the customer 110 corresponding to the identifier 225 has an account with. The voice engine 230 may make the determination using data stored by the contact center 150 and/or the external database 160. The voice engine 230 may then search for the determined brands 240 in the received text 223.

The voice engine 230 may be configured to initially greet the customer 110 when text 223 and an identifier 225 are received from voice assistant platform 150. For example, when the identifier 225 is received, the voice engine 230 may look for an account associated with the identifier 225 in one or both of the contact center 150 or the external database 160 (e.g., CRM platform). If such an account exists, the voice engine 230 may determine a name of the customer 110 and may instruct the voice assistant platform 150 to speak a greeting to the customer 110 that includes the name of the customer 110. If no account exists for the identifier 225, or no account can be located, the voice engine 230 may work with the customer 110 to create an account and to link the account to any brands 240 that the customer 110 may be associated with.

After determining the brand 240 for the text 223, the voice engine 230 may determine an intent 255 for the text 223. As described above, each intent 255 may be associated with one or more keywords. Accordingly, the voice engine 230 may determine an intent 225 from the text 223 by searching the text 223 for the keywords associated with each intent 255. Depending on the embodiment, the voice engine 230 may search for keywords of intents 255 associated with business processes 250 of the determined brand 240.

In some embodiments, if multiple intents 255 are determined for the text 223, the voice engine 230 may rank each determined intent 255 and may determine the intent 255 with the highest ranking. As one example, each intent 255 may have been assigned a priority that is related to its associated business process 250. The priority may have been assigned by a user or administrator when the intent 255 was associated with the business process 250 by the skill engine 220. The priority may be based on the popularity or overall usage of the business process 250 by the call center 150. The voice engine 230 may rank the determined intents 155 based on the assigned priorities. Any method or technique for ranking intents 255 may be used.

After determining the intent 255, the voice engine 230 may retrieve the business process 250 associated with the determined intent 255 from the external database 160. The voice engine 230 may then perform the business process 250 by performing one or more steps associated with the business process 250. One or more steps of the business process 250 may require or may reference data associated with the customer 110. Depending on the embodiment, the voice engine 230 may attempt to retrieve the customer data from the contact center or external database 160, and/or may instruct the voice assistant platform 150 to request the data from the customer 110 via the voice assistant 115.

For example, a business process 250 for returning an item may include the initial step of “Request the end user for their order number if not already known.” Accordingly, to process the step of the business process 250, the voice engine 230 may interface with the external database 160 to determine if there is an existing or outstanding order number for the customer 110. If an order number is determined, the voice engine 230 may use the determined order number, and/or may instruct the voice assistant platform 150 to ask the customer 110 to confirm the order number. If no order number is determined, or if there are multiple order numbers, the voice engine 230 may instruct the voice assistant platform 150 to ask the customer 110 to speak the order number.

In some embodiments, the voice engine 230 may further consider what is referred to a “context” when determining data for one or more steps of the business process 250. As used herein, the context may include some or all of the text 223 that has been provided by the voice assistant platform 150 for the customer 110, including the various words and phrases that were spoken by the customer 110 while using the skill 260.

Continuing the return example above, the text 223 may have included the phrase “I would like to return order number 234 to Shoebrand.” The voice engine 230 may have determined that the brand 240 for the text 223 was “Shoebrand” and the intent 255 was “return.” Accordingly, the voice engine 230 may have retrieved the business process 250 associated with the determined intent 255 for the brand 240 “Shoebrand.”

As shown above, the first step of the return business process 250 is “Request the end user for their order number if not already known.” Before requesting the order number from the external database or the voice assistant platform 150, the voice assistant may parse the context to determine if the order number was already mentioned by the customer 110. As shown above, the customer already spoke the number in the text 223 (i.e., “I would like to return order number 234 to Shoebrand.”). Accordingly, the voice engine 230 may retrieve the order number of 234 from the context and may use the order number to complete the step of the business process 250.

If there are no business processes 250 associated with a determined intent 255 (or no intent 255 can be determined), the voice engine 230 may interact with the contact center 150 to provide the customer 110 to an agent 120 associated with the brand 240. In some implementations, the voice engine 230 may connect the customer 110 to an agent 120 via the voice assistant platform 150. Accordingly, the agent 120 may communicate with the customer 110 through the voice assistant 115 associated with the customer 110. The voice engine 230 may also provide the agent 120 with any context associated with the customer 110 such as the text 223.

Alternatively, rather than have the agent 120 communicate with the customer 110 through the voice assistant 115, the voice engine 230 may determine a phone number (or other preferred communication means) associated with the customer 110 and may instruct an agent 120 to contact the customer 110 at the determined number. The agent 120 may be provided the context associated with the customer 110 as described above. The voice engine 130 may further instruct the voice assistant platform 150 to let the customer 110 know that an agent 120 will be calling.

Furthermore, in some embodiments, the voice engine 230 may instruct an agent 120 to call, or otherwise communicate with, a customer 110 upon detecting certain keywords in the text 223. For example, if the customer speaks keywords and phrases such as “help,” “agent”, “human”, etc., the voice engine 230 may instruct an agent 120 to call the customer 110 at an associated number.

As may be appreciated, the skill engine 220 and voice engine 230 provide many advantages over the prior art. First, by incorporating a plurality of brands 240 into a single skill 260, the customers 110 associated with the brands 240 may be incentivized to install the skill 260 because of the number of brands 240 that they will be able to communicate with via their voice assistants 115. Second, by allowing brands 240 to use their existing business processes 250 from a call center 150 in a skill 260, the difficulty and expense in creating and maintaining a skill 260 for a brand 240 is greatly reduced. Third, by encouraging customers 110 to interact with a brand 240 through a voice assistant 110 rather than through an agent 120, the costs associated with customer 110 interactions for the brand 240 may be reduced.

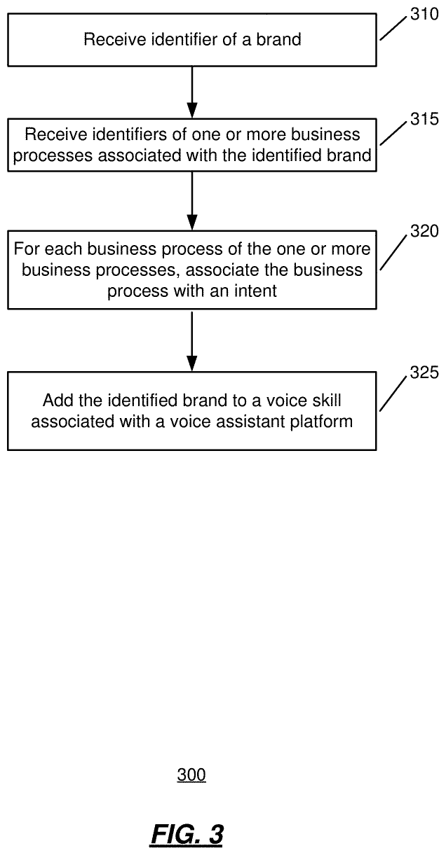

FIG. 3 is an illustration of an example method 300 for adding a brand 240 to a voice skill 260. The method 300 may be implemented by the skill engine 220 of the contact center 150.

At 310, an identifier of a brand may be received. The identifier of a brand 240 may be received by the skill engine 220 of the contact center 150. The identifier of a brand 240 may have been received in response to a user or administrator associated with the brand 240 determining to add the brand 240 to a skill 260. The skill 260 may be for a voice assistant platform 150. The brand 240 may be a client of the contact center 150. For example, the brand 240 may use the contact center 150 to handle calls and other communications for the brand 240 according to one or more business processes 250. The business processes 250 may be stored at the contact center 150 or on one or more external databases 160. An example external database 160 is a CRM platform, for example.

At 315, identifiers of one or more business processes associated with the identified brand are received. The identifiers of the one or more business processes 250 may be received by the skill engine 220. The one or more business processes 250 may be received from one or both of the contact center 150 or the external database 160.

At 320, for each business process of the one or more business processes, the business process is associated with an intent. Each business process may be associated with an intent by the skill engine 220. An intent 255 may be one or more keywords or phrases that when present in text 223 received from the voice assistant platform 150 may trigger the associated business process 250. Depending on the embodiment, the keywords and phrases that comprise the intents 255 may be provided by a user or administrator associated with the identified brand 240 or may be selected automatically by the skill engine 220 using artificial intelligence, for example.

At 325, the identified brand is added to a voice skill associated with a voice assistant platform. The brand 240 may be added to the skill 260 associated with the voice assistance platform 150 by the skill engine 220. The skill 260 may include a plurality of brands 260.

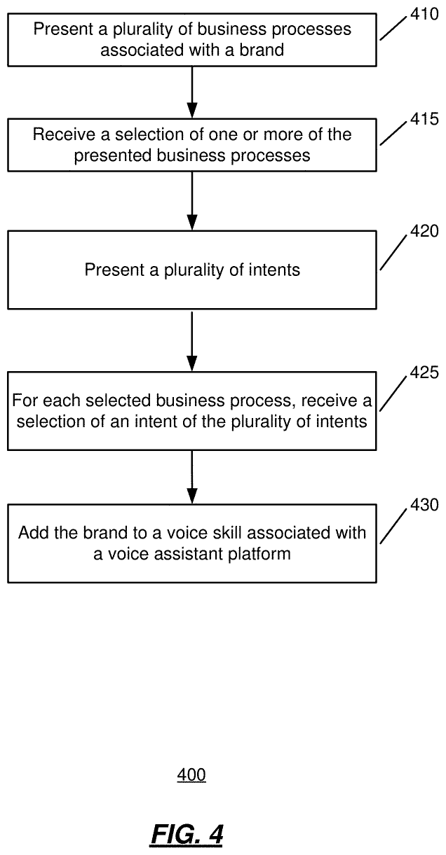

FIG. 4 is an illustration of an example method 400 for adding a brand 240 to a voice skill 260. The method 400 may be implemented by the skill engine 220 of the contact center 150.

At 410, a plurality of business processes associated with a brand are presented. The business processes 250 may be presented in a GUI being used by a user or administrator associated with the brand 240 to select business processes 250 to incorporate into a skill 260. The business processes 250 may be existing business processes 250 used by the brand 240 with respect to a call center 150. The business processes 250 may have been received from a CRM platform associated with or used by the brand 240.

At 415, a selection of one or more business processes is received. The selection may be received by the skill engine 220 from the GUI. The user or administrator may have selected the one or more business processes 250 to incorporate into the skill 260.

At 420, a plurality of intents is presented. The plurality of intents 255 may be presented in the GUI to the user or administrator. The presented intents 255 may be “suggested intents” for the selected business processes 250. The intents 255 may have been selected based on word or phrases associated with the business processes 250 or may have been selected based on intents 255 used by other brands 240 for similar business processes 250. Each intent 255 may include a plurality of words or phrases. Depending on the embodiment, the user or administrator may add or modify each intent 255 in the GUI.

At 425, for each selected business process, a selection of an intent of the plurality of intents is received. The selection of an intent 255 may be received by the skill engine 220 via the GUI. Some or all of the intents 255 may be selected by the user or administrator associated with the brand 240. Each selected intent 255 will trigger its corresponding business process 250 when provided from the voice assistant platform 150 as part of the skill 260.

At 430, the brand is added to a voice skill associated with a voice assistant platform. The brand 240 may be added to the skill 260 associated with the voice assistance platform 150 by the skill engine 220. The skill 260 may include a plurality of brands 260.

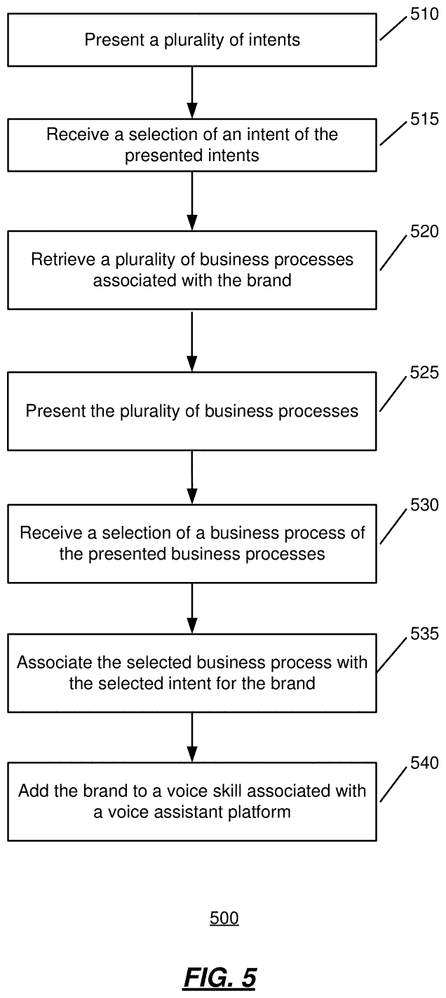

FIG. 5 is an illustration of an example method 500 for adding a brand 240 to a voice skill 260. The method 500 may be implemented by the skill engine 220 of the contact center 150.

At 510, a plurality of intents is presented. The plurality of intents 255 may be presented in a GUI to a user or administrator associated with a brand 240. Each intent 255 may include one or more keywords.

At 515, a selection of an intent is received. The selection of an intent 255 may be received by the skill engine 220 through the GUI from the user or administrator associated with the brand 240.

At 520, a plurality of business processes associated with the brand is retrieved. The plurality of business processes 250 may be retrieved by the skill engine 220 from the external database 160 and/or the contact center 150.

At 525, the plurality of business processes 250 is presented. The plurality of business processes 250 may be presented by the skill engine 220 to the user or administrator associated with the brand 240 in the GUI.

At 530, a selection of a business process of the presented business processes is received. The selection of a business process 250 may be received by the skill engine 220 through the GUI from the user or administrator associated with the brand 240.

At 535, the selected business process is associated with the selected intent for the brand. The selected business process 250 may be associated with the selected intent 255 by the skill engine 220

At 540, the brand is added to a voice skill associated with a voice assistant platform. The brand 240 may be added to the skill 260 associated with the voice assistance platform 150 by the skill engine 220. The skill 260 may include a plurality of brands 260.

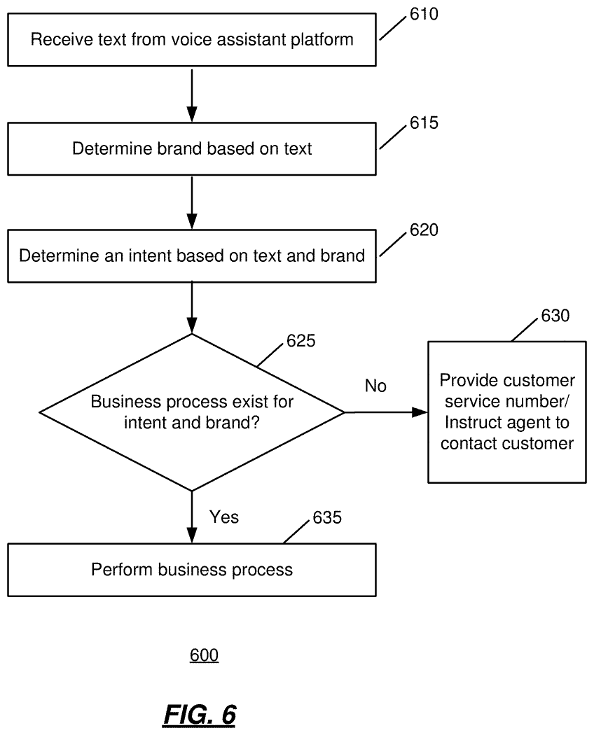

FIG. 6 is an illustration of an example method 600 for performing a business process for a brand based on text received from a voice assistant platform. The method 600 may be performed by the voice engine 230 of the contact center 150.

At 610, text is received from a voice assistant platform. The text 223 may be received by a voice engine 230 of the contact center 150. The text 223 may be transcription of voice data provided by a customer 110 using a voice assistant 115. The text 223 may further be received along with an identifier 225 that identifies the customer 110 to the contact center 150.

At 615, a brand is determined based on the text. The brand 240 may be determined based on the text 223 by the voice engine 230. For example, the voice engine 230 may process the text 223 looking for a keyword or phrase that is associated with a brand 240. In some embodiments, the voice engine 230 may determine the brand 240 by determining brands 240 that are associated with the identified customer 110. For example, the voice engine 230 may look for brands 240 that the customer 110 has an account with. The determination may be based on information associated with the brand 240 in a CRM platform.

At 620, an intent is determined based on the text and the brand. The intent 255 may be determined by the voice engine 230. In some embodiments, the voice engine 230 may determine some or all of the intents 255 associated with the brand 240 and may determine if any of the intents 255 associated with the brand 240 match the text 223. The matching intents 255 are the determined intents 255 for the text 223 and brand 240. If multiple intents 255 match the text 223, the voice engine 230 may select the intent 255 having a highest priority, for example.

At 625, a determination is made as to whether a business process exists for the determined intent and brand. Whether a business process 250 exists may be determined by the voice engine 230. If a business process 250 exists, the method 600 may continue at 635. Else, the method 600 may continue at 630.

At 630, in response to no business process existing, the voice engine 230 may take one or more default actions with respect to the text 223. In one embodiment, the voice engine 230 may determine a customer service number associated with the brand 240 (from the contact center 150 or the external database 160) and may instruct the voice assistant platform 150 to speak the customer service number to the customer 110 via the voice assistant 115. The customer service number may be provided along with instructions for the customer 110 to call the customer service number.

In another embodiment, the voice engine 230 may instruct an agent 120 to contact the customer 110. The agent 120 may be instructed to contact the customer 110 via the voice assistant 115 or using a telephone number associated with the customer 110. The agent 120 may further be provided a context that includes the text 223 and other information about the customer 110 such as their name and order history with respect to the brand 240. The voice engine 230 may further instruct the voice assistant platform 150 to let the customer 110 know, via the voice assistant 115, that an agent 120 will be calling them.

At 630, the business process is performed. The business process 250 may be performed by the voice engine 230. Depending on the embodiment, the voice engine 230 may require additional information or data from the customer 110 to complete one or more steps of the business process 250. In such cases, the voice engine 230 may instruct the voice assistant platform 150 to request the data from the customer 110 via the voice assistant 115. Any method or technique for performing a business process 250 may be used.

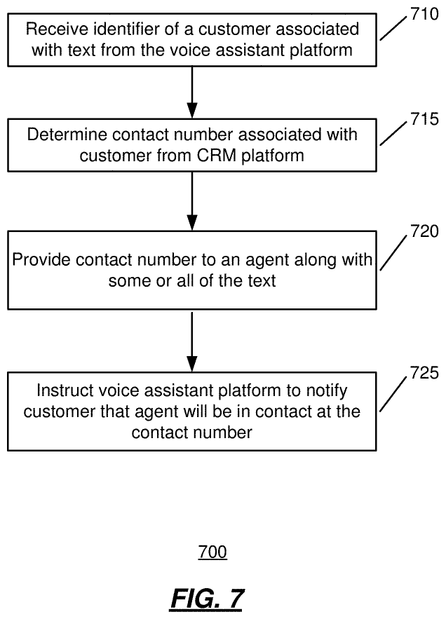

FIG. 7 is an illustration of an example method 700 for instructing an agent to contact a customer. The method 700 may be implemented by the voice engine 230 of the contact center 150.

At 710, an identifier of a customer associated with text from a voice assistant platform is received. The identifier 225 may be received by the voice engine 230 along with the text 223 from the voice assistant platform 150. The text 223 may be a transcription of voice data provided by the identified customer 110 to a skill 260 executed by a corresponding voice assistant 115. The voice data may represent a request of the customer 110 for the skill 260 with respect to a brand 240 of a plurality of brands 240 associated with the skill 260.

At 715, a contact number associated with the customer is determined. The contact number associated with the customer 110 may be determined by the voice engine 110 from the contact center 150 and/or the external database 160. The external database 160 may be a CRM platform. Other types of databases or platforms may be supported. The contact number may be phone number, however other contact methods may be supported such as email, for example.

At 720, the contact number is provided to an agent along with some or all of the text. The contact number may be provided by the voice engine 230 to the agent 120. The voice engine 230 may provide the text 223, along with other context information, so that the agent 120 may determine why the customer 110 contacted the brand 240 using the voice assistant 115.

At 725, the voice assistant platform is instructed to notify customer that an agent will be in contact using the contact number. The instruction may be provided by the voice engine 230 to the voice assistant platform.

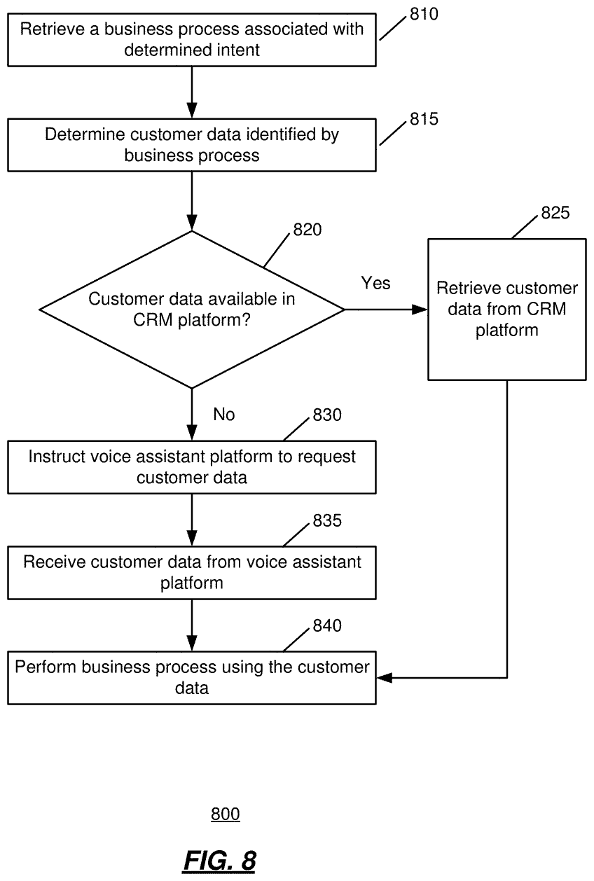

FIG. 8 is an illustration of an example method 800 for performing a business process associated with a determined intent. The method 800 may be performed by the voice engine 230 of the contact center 150.

At 810, business process associated with a determined intent is retrieved. The business process 250 may be retrieved by the voice engine 230 from a CRM platform. The business process 250 may be associated with a brand 240. The brand 240 and the intent 255 may have been determined by the voice engine 230 from text 223 received from a voice assistant platform 150. The text 223 may be generated from voice data provided by a customer 110 of the brand 240 using a skill 260 installed on their voice assistant 115.

At 820, customer data identified by the business process is determined. The customer data may be identified by the voice engine 230. The customer data may be a variety of data about the customer 110 such as a customer account number, order number, address, credit card number etc. The customer data may be used by one or more steps of the business process 250.

At 820, a determination is made as to whether the customer data is available in the CRM platform. The determination may be made by the voice engine 230 by querying the CRM platform for the data, for example. The voice engine 230 may further determine if the customer data is available in the text 223, or if the customer data is available in the contact center 150. As may be appreciated, because the contact center 150 performs one or more business processes 250 associated with the brand 240 for callers some of the customer data may be available to the contact center 150. If the customer data is available, the voice engine 230 may retrieve the customer data at 825. Else, the method 800 may continue at 830.

At 830, the voice assistant platform is instructed to request the customer data from the customer. The instruction may be provided by the voice engine 230 to the voice assistant platform 150. Upon receiving the instruction, the voice assistant platform 150 may cause audio data corresponding to the instruction to be played to the customer 110 through their voice assistant 115.

At 835, customer data is received from the voice assistant platform. The customer data may be received by the voice engine 230 from the voice assistant platform 150. The customer data may be received as text 223.

At 840, the business process is performed using the customer data. The business process 240 may be performed by the voice engine 230.

FIG. 9 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 900. In its most basic configuration, computing device 900 typically includes at least one processing unit 902 and memory 904. Depending on the exact configuration and type of computing device, memory 904 may be volatile (such as random access memory (RAM)), non-volatile (such as read-only memory (ROM), flash memory, etc.), or some combination of the two. This most basic configuration is illustrated in FIG. 9 by dashed line 906.

Computing device 900 may have additional features/functionality. For example, computing device 900 may include additional storage (removable and/or non-removable) including, but not limited to, magnetic or optical disks or tape. Such additional storage is illustrated in FIG. 9 by removable storage 908 and non-removable storage 910.

Computing device 900 typically includes a variety of tangible computer readable media. Computer readable media can be any available tangible media that can be accessed by device 900 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 904, removable storage 908, and non-removable storage 910 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 900. Any such computer storage media may be part of computing device 900.

Computing device 900 may contain communications connection(s) 912 that allow the device to communicate with other devices. Computing device 900 may also have input device(s) 914 such as a keyboard, mouse, pen, voice input device, touch input device, etc. Output device(s) 916 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
presenting a plurality of intents by a computing device;
receiving a selection of an intent of the presented plurality of intents by the computing device;
retrieve a plurality of business processes associated with a brand by the computing device;
present the plurality of business processes by the computing device;
receiving a selection of a business process of the plurality of business processes by the computing device;
associating the selected business process with the selected intent for the brand by the computing device; and
adding the brand to a voice skill associated with a voice assistant platform by the computing device.

2. The method of claim 1, further comprising:
receiving one or more keywords for the selected intent; and
associating the one or more keywords with the selected intent.

3. The method of claim 1, wherein voice skill includes a plurality of brands.

4. The method of claim 1, further comprising:
receiving text through the skill from the voice assistant platform;
determining the brand based on the text;
determining the intent based on the text;
retrieving the business process for the brand that is associated with the determined intent; and
performing the retrieved business process.

5. The method of claim 4, wherein the received text is associated with a customer and performing the retrieved business process comprises:
determining customer data identified by the business process;
providing instructions to the voice assistant platform to ask the customer for the identified customer data; and
receiving the identified customer data from the voice assistant platform.

6. The method of claim 1, wherein each intent comprises a plurality of keywords.

7. The method of claim 1, wherein the plurality of business processes is retrieved from a CRM platform.

8. A system comprising:
at least one processor; and
at least one non-transitory computer-readable storage medium storing instructions thereon that, when executed by the at least one processor, cause the system to:
present a plurality of intents;
receive a selection of an intent of the presented plurality of intents;
retrieve a plurality of business processes associated with a brand;
present the plurality of business processes;
receive a selection of a business process of the plurality of business processes;
associate the selected business process with the selected intent for the brand; and
add the brand to a voice skill associated with a voice assistant platform.

9. The system of claim 8, further storing instructions thereon that, when executed by the at least one processor, cause the system to:
receive one or more keywords for the selected intent; and
associate the one or more keywords with the selected intent.

10. The system of claim 8, wherein voice skill includes a plurality of brands.

11. The system of claim 8, further storing instructions thereon that, when executed by the at least one processor, cause the system to:
receive text through the skill from the voice assistant platform;
determine the brand based on the text;
determine the intent based on the text;
retrieve the business process for the brand that is associated with the determined intent; and
perform the retrieved business process.

12. The system of claim 11, wherein the received text is associated with a customer and performing the retrieved business process comprises:
determining customer data identified by the business process;
providing instructions to the voice assistant platform to ask the customer for the identified customer data; and
receiving the identified customer data from the voice assistant platform.

13. The system of claim 8, wherein each intent comprises a plurality of keywords.

14. The system of claim 8, wherein the plurality of business processes is retrieved from a CRM platform.

15. A non-transitory computer-readable medium storing instructions thereon that, when executed by at least one processor, cause a computer system to:
present a plurality of intents;
receive a selection of an intent of the presented plurality of intents;
retrieve a plurality of business processes associated with a brand;
present the plurality of business processes;
receive a selection of a business process of the plurality of business processes;
associate the selected business process with the selected intent for the brand; and
add the brand to a voice skill associated with a voice assistant platform.

16. The computer-readable medium of claim 15, further storing instructions thereon that, when executed by the at least one processor, cause the computer system to:
receive one or more keywords for the selected intent; and
associate the one or more keywords with the selected intent.

17. The computer-readable medium of claim 15, wherein voice skill includes a plurality of brands.

18. The computer-readable medium of claim 15, further storing instructions thereon that, when executed by the at least one processor, cause the computer system to:
receive text through the skill from the voice assistant platform;
determine the brand based on the text;
determine the intent based on the text;
retrieve the business process for the brand that is associated with the determined intent; and
perform the retrieved business process.

19. The computer-readable medium of claim 18, wherein the received text is associated with a customer and performing the retrieved business process comprises:
determining customer data identified by the business process;
providing instructions to the voice assistant platform to ask the customer for the identified customer data; and
receiving the identified customer data from the voice assistant platform.

20. The computer-readable medium of claim 15, wherein each intent comprises a plurality of keywords.
